(19) United States
(12) Patent Application Publication
(10) Pub. No.: US 2015/0195629 A1
(43) Pub. Date: Jul. 9, 2015

(54) PASSIVE RADIATOR

(71) Applicant: Sound Sources Technology, Inc., Torrance, CA (US)

(72) Inventors: Yoichiro Sumitani, Rancho Palos Verdes, CA (US); Junji Iino, Gunma Prefecture (JP)

(73) Assignee: Sound Sources Technology, Inc., Torrance, CA (US)

(21) Appl. No.: 14/148,476

(22) Filed: Jan. 6, 2014

(51) Int. Cl. H04R 1/00

(52) U.S. Cl. CPC H04R 1/00

(57) ABSTRACT

A passive acoustic radiator has a forward radiating element and a reverse radiating element each defined by a front face and an opposed rear face. A forward diaphragm is coupled to a forward surround defined by an annular raised side coinciding with the forward front face and an opposed annular trough side coinciding with the forward rear face. A reverse diaphragm is coupled to a reverse surround defined by an annular raised side coinciding with the reverse front face and an opposed annular trough side coinciding with the reverse rear face. The forward radiating element and the reverse radiating element are attached to each other with the forward rear face being in an abutting relationship to the reverse rear face. An annular open space is defined at least partially by the respective trough sides of the forward and reverse radiating elements.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to loudspeakers, and more particularly, to passive acoustic radiators.

2. Related Art

Loudspeakers are universally known and utilized in audio systems for the reproduction of sound. Essentially, loudspeakers are transducers which convert electrical energy to acoustic energy. There are a wide variety of designs employing various operational principles, though the most common is the electro-dynamic variety, in which an electrical signal representative of the desired audio is applied to a voice coil wound around a bobbin and suspended between opposite poles of a magnet. The region between the poles is known as the air gap, and the magnetic field present therein interacts with the electrical current passed through the voice coil. The electromagnetic force moves the bobbin/voice coil along the air gap, and the displacement or movement thereof is controlled by the magnitude and direction of current in the coil and the resulting axial forces. The bobbin is also attached to a cone-shaped semi-rigid diaphragm, and the vibration of the bobbin is correspondingly transferred thereto. The base of the diaphragm is generally suspended from the rim of the loudspeaker basket, and provides lateral stability. The apex of the diaphragm generally includes a damper, also known in the art as a spider, which is a ring-shaped member having an interior edge that may be secured to the bobbin and an exterior edge that may be secured to the basket. The damper resiliently supports the bobbin at the respective predetermined static positions within the air gap without the voice coil contacting the surrounding surfaces of the yoke or the magnet.

In general, loudspeaker designs aim for the faithful re-creation of the sound or acoustic waveform represented by the electrical signal. The typical acoustic waveform is a combination of continuous waveforms of different magnitudes, frequencies, and phases, and unfortunately, a single loudspeaker driver cannot reproduce sounds across the entire audible frequency range. This is understood to due to the limitations imposed by weight and size of the diaphragm and bobbin. Thus, loudspeaker systems employ multiple drivers, each being configured for a particular frequency range. There may be a tweeter for high frequency sound reproduction in the range of approximately 2,000 to 20,000 Hz, a midrange driver which is capable of reproducing frequencies in the range of 300 to 5,000 Hz, and a woofer for bass/low frequency sound in the range of 40 to 1,000 Hz. Regardless of the frequency range or driver type, that is, whether the driver is classified as a tweeter, midrange, or woofer, the basic components of an electrodynamic loudspeaker are the same as discussed generally above.

There are speaker systems in which different range drivers are integrated into a single enclosure, as well systems with dedicated units for each driver or multiple drivers in the same frequency range. Particularly for the enhanced reproduction of the lowest bass sounds that cannot be produced clearly from smaller mid-range/tweeter units, subwoofers are employed. In order to generate the needed sound pressure levels at the lower frequency ranges, the woofer drivers are larger in size, with attendant increases in weight and electrical power requirements. For this reason, most subwoofers utilize an on-board amplifier that is also integrated into the enclosure.

Depending on the desired response, the subwoofer enclosure may be configured in a variety of different ways. One possible configuration is the sealed enclosure, whereby the back wave from the woofer driver is isolated within the enclosure. Alternatively, there are ported designs in which air (and attendant pressure waves thereof generated by the woofer driver) is allowed to escape the enclosure, resulting in greater efficiency and higher output levels. The enclosure typically defines an opening, to which a hollow tube is interfaced. Compared to sealed designs, ported designs tend to have a poorer transient response, and the port diameters, enclosure volume, tube length, and driver parameters must be meticulously tuned to achieve the best response.

A variation of the ported design involves the use of passive radiators substituted for the aforementioned ports. A passive radiator can be the same driver unit as that utilized for the woofer driver, but with the voice coils and magnets removed. The reciprocating movement of the electromagnetically driven primary driver causes pressure level fluctuations from the rear of the diaphragm, which in turn induces movement of the passive radiator diaphragm. Over conventional ported designs, passive radiators can output the same sound levels but with a much smaller enclosure footprint. Furthermore, the response of the active woofer driver can be dampened and the excursion of the diaphragm/surround can be reduced.

Aside from utilizing the woofer driver without voice coils and magnets, there are dedicated passive radiator designs that are comprised of a flat diaphragm suspended from an opening in the enclosure with a suspension/surround. Tuning of the passive radiation generally involves matching the weight of the diaphragm with that of the active woofer driver. However, conventional designs tend to induce a rolling or rotation transverse to the reciprocation axis of the diaphragm, causing flutter noise and other distortion of the output. Accordingly, there is a need in the art for an improved passive radiator.

### BRIEF SUMMARY

Various embodiments of the present disclosure contemplate a passive acoustic radiator. There may be a forward radiating element that is defined by a forward front face and an opposed forward rear face. Furthermore, the forward radiating element may include a forward diaphragm that may be coupled to a forward surround that is defined by an annular raised side coinciding with the forward front face and an opposed annular trough side coinciding with the forward rear face. There may be a reverse radiating element that is similarly defined by a reverse front face and an opposed reverse rear face. The reverse radiating element may include a reverse diaphragm that is coupled to a reverse surround defined by an annular raised side coinciding with the reverse front face and an opposed annular trough side coinciding with the reverse rear face. The forward radiating element and the reverse radiating element may be attached to each other with the forward rear face of the forward radiating element being in an abutting relationship to the reverse rear face of the reverse radiating element. An annular open space may be defined at least partially by the respective trough sides of the forward and reverse radiating elements.

According to another embodiment, a passive radiator is disclosed. It may have a forward surround defined by a front surround surface and an opposed rear surround surface. Additionally, there may be a forward outer gasket that is defined by a front outer gasket surface attached to the rear surround surface of the forward surround, and an opposed rear outer gasket surface. The passive radiator may further include a forward diaphragm defined by a front diaphragm surface and an opposed rear diaphragm surface. The front diaphragm surface may be attached to the rear surround surface of the forward surround. There may further be a reverse surround that is defined by a front surround surface and an opposed rear surround surface. The passive radiator may also include a reverse outer gasket defined by a front outer gasket surface attached to the rear surround surface of the reverse surround, and an opposed rear outer gasket surface attached to the rear outer gasket surface of the forward outer gasket. There may also be a reverse diaphragm that is defined by a front diaphragm surface and an opposed rear diaphragm surface. The front diaphragm surface of the reverse diaphragm may be attached to the rear surround surface of the reverse surround, while the rear diaphragm surface of the reverse diaphragm may be attached to the rear diaphragm surface of the forward diaphragm. In one variation, the surrounds may be annular and characterized by an inner flange, and outer flange, and a cross-sectionally arcuate raised section therebetween, while in another variation, the surrounds may be characterized by an outer flange, and inner planar portion, and a cross-sectionally arcuate raised section therebetween.

Another embodiment further contemplates a passive radiator. There may be a forward surround that is defined by a front surround surface, an opposed rear surround surface, an outer flange portion, and an inner planar portion. There may also be a forward outer gasket that is defined by a front outer gasket surface and an opposed rear outer gasket surface that can be attached to the outer flange portion of the forward surround. The passive radiator may further include a forward diaphragm that is defined by a front diaphragm surface and an opposed rear diaphragm surface attached to the inner planar portion of the forward surround. Moreover, there may be a reverse surround that is defined by a front surround surface, an opposed rear surround surface attached to the rear surround surface of the forward surround, an outer flange portion, and an inner planar portion. The passive radiator may include a reverse outer gasket that is defined by a front outer gasket surface and an opposed rear outer gasket surface attached to the outer flange portion of the reverse surround. There may also be a reverse diaphragm that is defined by a front diaphragm surface and an opposed rear diaphragm surface attached to the inner planar portion of the reverse surround.

The presently contemplated embodiments will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a simplified cross-sectional view of a sub-woofer enclosure with active woofer drivers and a passive radiator in accordance with various embodiments of the present disclosure;

FIG. 2 is an exploded perspective view of a first embodiment of the passive radiator;

FIG. 3 is a cross-sectional view of the first embodiment of the passive radiator;

FIG. 4 is an exploded perspective view of a second embodiment of the passive radiator;

FIG. 5 is a cross-sectional view of the second embodiment of the passive radiator;

FIG. 6 is an exploded perspective view of a third embodiment of the passive radiator; and

FIG. 7 is a cross-sectional view of the third embodiment of the passive radiator.

Common reference numerals are used throughout the drawings and the detailed description to indicate the same elements.

### DETAILED DESCRIPTION

The detailed description set forth below in connection with the appended drawings is intended as a description of the presently preferred embodiments of a passive radiator, and is not intended to represent the only form in which the present apparatus may be developed or utilized. The description sets forth the functions and features of the passive radiator in connection with the illustrated embodiment. It is to be understood, however, that the same or equivalent functions may be accomplished by different embodiments that are also intended to be encompassed within the present disclosure. It is further understood that the use of relational terms such as top, bottom, forward, reverse, front, rear and the like are used solely to distinguish one from another entity without necessarily requiring or implying any actual such relationship or order between such entities.

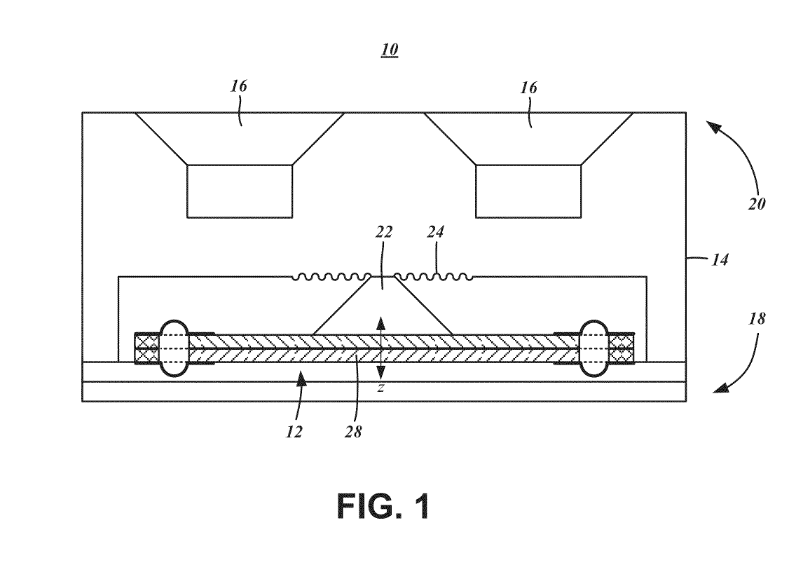

Referring now to FIG. 1, an exemplary subwoofer unit 10 is shown with a passive radiator 12 in accordance with one embodiment of the present disclosure. The subwoofer unit 10 is generally comprised of an enclosure 14, along with active woofer drivers 16 that output sound in response to corresponding electrical signals from a source (not shown). The various components and functional principles of electro-dynamic loudspeakers are well known in the art, and a brief overview thereof has been presented above in the background of the disclosure. Accordingly, such details will not be repeated. Although the passive radiator 12 is shown mounted on a rear portion 18 of the enclosure 14 (relative to a front portion 20, towards which the active woofer drivers 16 are mounted), this is by way of example only and not of limitation. The passive radiator 12 may be mounted on any other suitable location of the enclosure 14. As is conventional with mounting existing passive radiators in subwoofers, there may be a stabilization platform 22 that is coupled to a flexible radial spider 24 mounted on a frame 26, and a diaphragm 24 of the passive radiator 12. The frame 26, in turn, is understood to be mounted to the enclosure 14.

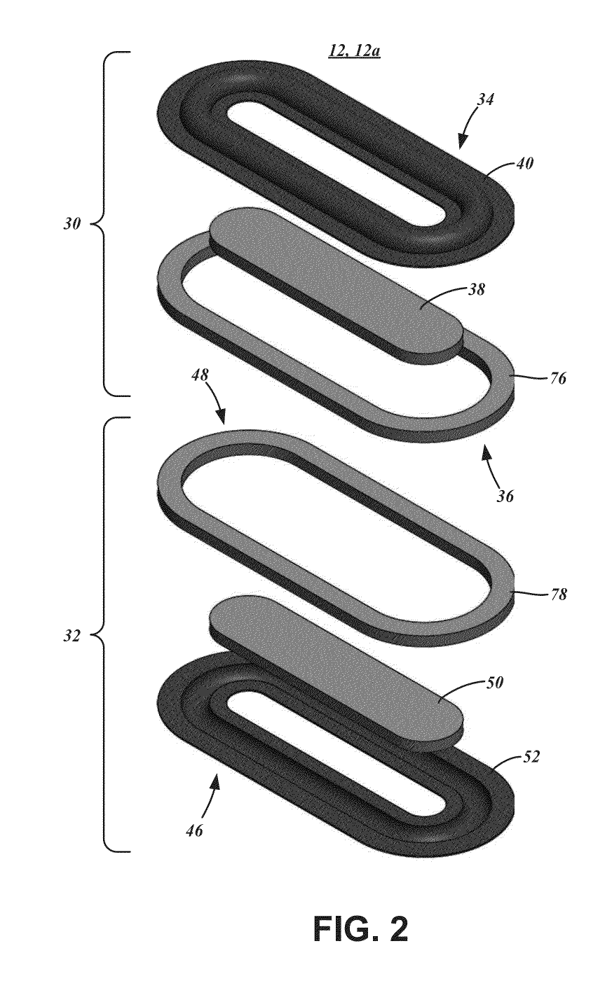

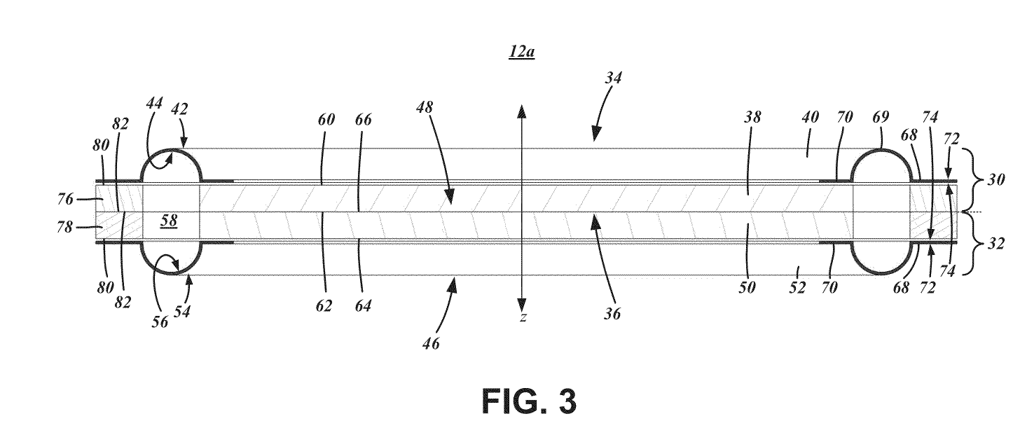

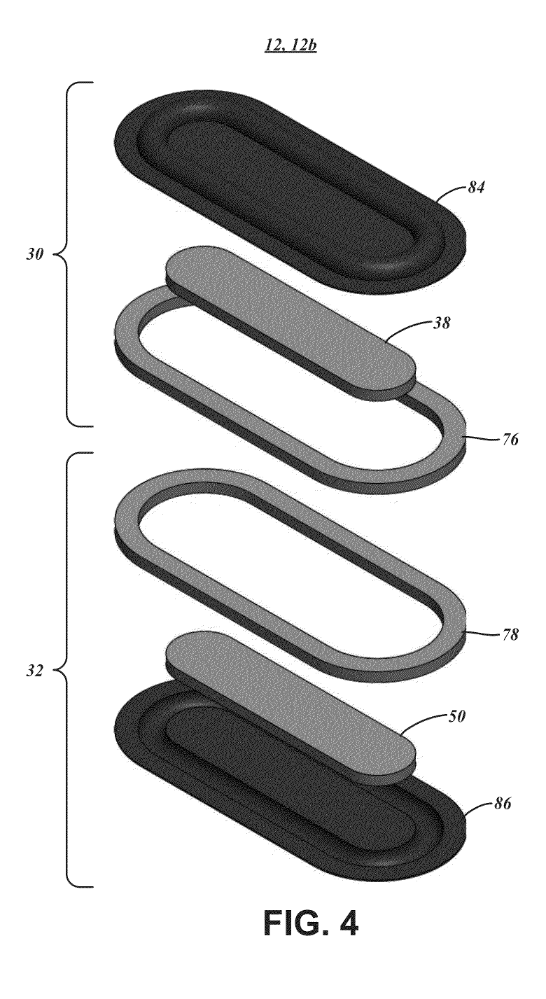

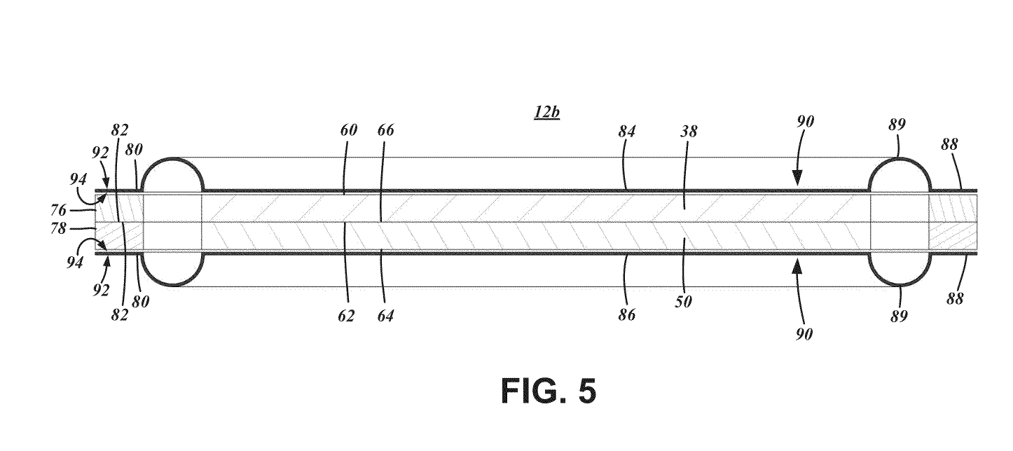

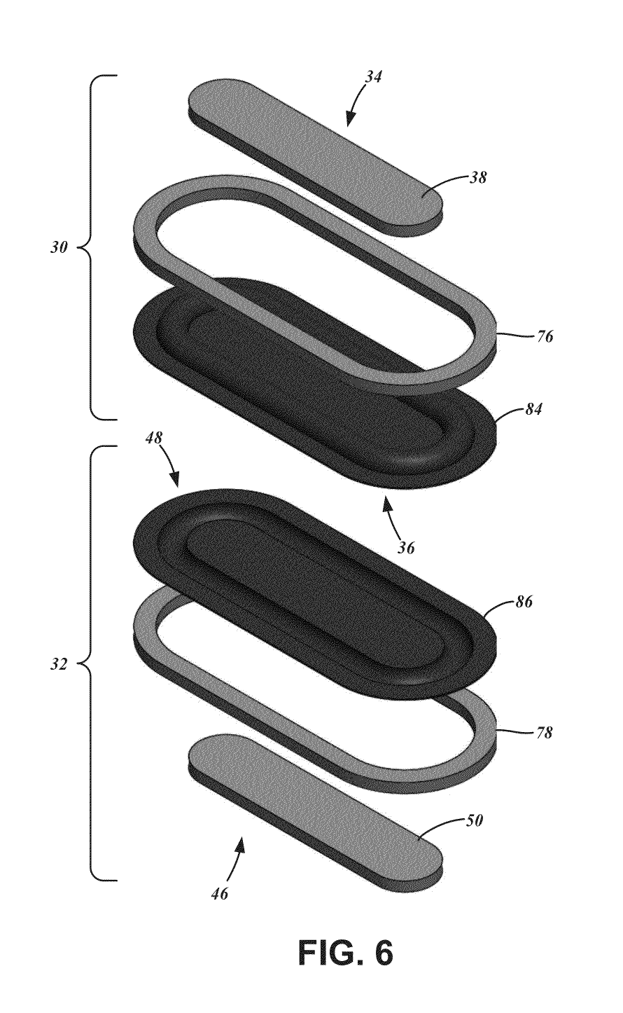

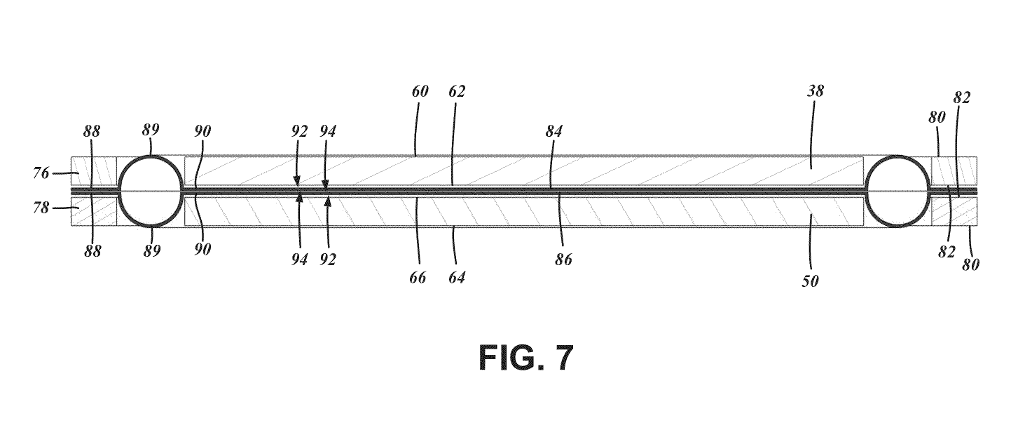

In general, the passive radiator 12 is understood to respond to the back pressure waves from the active woofer drivers 16 and reciprocate along a vibration axis z. The passive radiator 12 is understood to increase the efficiency of bass output for a given electrical amplification level because a substantially greater diaphragm surface area is being used to output sound. However, conventional passive radiators tend to exhibit off-axis rotation that causes flutter and other sonic distortion, and so improvements in this regard are contemplated in the various exemplary embodiments of the passive radiator 12, including a first embodiment 12a shown in FIGS. 1, 2, and 3, a second embodiment 12b shown in FIGS. 4 and 5, and a third embodiment 12c shown in FIGS. 6 and 7. These multiple embodiments share common features which will be described with reference to the first embodiment 12a shown in further detail in FIGS. 2 and 3. In this regard, those having ordinary skill in the art will recognize those aspects of the alternative embodiments that correspond to such common features. To the extent any features specific to one of the three embodiments are being considered, reference will be made to the specific variation of the passive radiator 12a-12c. When common features are being considered, reference will be made to the passive radiator 12 generally.

The passive radiator 12 is generally comprised of a forward radiating element 30 and a reverse radiating element 32. Although each depiction of the various embodiments of the passive radiator 12 shows a rounded rectangle profile, this is by way of example only and not of limitation. Any other suitable profile may be substituted without departing from the present disclosure. As will be discussed in further detail, the forward radiating element 30 and the reverse radiating element 32 may be identically configured, and the terms forward and reverse are utilized for distinguishing one radiating element from the other without requiring any particular one to be facing forward/outward or reverse/inward relative to the enclosure 14. The forward radiating element 30 is defined by a forward front face 34 and an opposed forward rear face 36. Additionally, the forward radiating element 30 includes a forward diaphragm 38 that is coupled to a forward surround 40.

The forward surround 40 is understood to be defined by an annular raised side 42 coinciding with the forward front face 34, that is, the annular raised side 42 is part of what defines the forward front face 34 of the more broadly described forward radiating element 30. Furthermore, the forward surround 40 is defined by an opposed annular trough side 44 coinciding with the forward rear face 36, which, again, is understood to refer to the annular trough side 44 being a part of what defines the forward rear face 36.

The reverse radiating element 32 is similarly defined by a reverse front face 46 and an opposed reverse rear face 48. There is also a reverse diaphragm 50 that is coupled to a reverse surround 52, which in turn is defined by an annular raised side 56 and an opposed annular trough side 56. The annular raised side 56 is understood to coincide with the reverse front face 46, while the annular trough side 56 is understood to coincide with the reverse rear face 48.

In accordance with various embodiments of the present disclosure, the forward radiating element 30 is attached to the reverse radiating element 32. More particularly, the forward rear face 36 of the forward radiating element 30 is in an abutting relationship to the reverse rear face 48 of the reverse radiating element 32. The forward radiating element 30 and the reverse radiating element, and in particular the annular trough sides 44, 56 at least partially define an open space 58 within the interior of the passive radiator 12. The forward surround 40 and the reverse surround 52 are understood to be constructed of resilient yet flexible material that allows limited movement or reciprocation of the diaphragms 38, 50 along an axis z-z. In accordance with one preferred, though optional embodiment of the present disclosure, the thickness of the surrounds 40, 52 is 0.3 mm. The forward and reverse surrounds 40, 52 that face each other in the illustrated configuration are understood to minimize rotation that is transverse to the y-y axis.

Having considered the features that are common to the three disclosed embodiments of the passive radiator 12a-12c, additional features that are specific to each will now be described. Again, FIGS. 2 and 3 depict the first embodiment 12a in which the forward diaphragm 38 and the reverse diaphragm 50 abut against each other, and the forward surround 40 and the reverse surround 52 have an annular configuration whereby the diaphragms 38, 50 are exposed. In further detail, the forward diaphragm 38 is defined by a front face 60, also referred to as a front diaphragm surface, as well as an opposed rear face 62, also referred to as a rear diaphragm surface, that coincides with the forward rear face 36 of the forward radiating element 30. The reverse diaphragm 50 is defined by a front face 64, also referred to as a front diaphragm surface, and an opposed rear face 66, also referred to as a rear diaphragm surface, that coincides with the reverse rear face 48 of the reverse radiating element 32. As illustrated in FIG. 3, the rear face 62 of the forward diaphragm 38 is in an abutting relationship to the rear face 55 of the reverse diaphragm 50. In this embodiment, as well as others in which the forward and reverse diaphragms 38, 50 abut each other, glue or any suitable adhesive may be utilized to bond the two surfaces together. Preferably, though optionally, the diaphragms 38, 50 are constructed of cardboard and have substantially the same thickness.

As indicated above, the forward surround 40 and the reverse surround 52 have a conventional annular configuration and include an outer flange 68 and an inner flange 70 each having a top surface 72 and an opposed bottom surface 74. Interposed between the outer flange 68 and the inner flange 70 is a cross-sectionally arcuate raised section 69. The semi-circular profile of the arcuate raised section 69 as shown in this and other embodiments is by way of example only and not of limitation, and any other suitable profile known in the art may be substituted without departing from the present invention. The top surface 72 may also be referred to as a front surround surface, while the bottom surface 74 may also be referred to as a bottom surround surface. In this context, the front face 60, e.g., the front diaphragm surface of the forward diaphragm 38, attaches to the bottom surface 74 of the forward surround 40. Likewise, the front face 60, e.g., the front diaphragm surface of the reverse diaphragm 50 attaches to and abuts the bottom surface 74 of the reverse surround 52.

With the annular configuration of the forward surround 40 and the reverse surround 52, in accordance with the first embodiment of the passive radiator 12a, it is contemplated that the respective inner flange 70 is what attaches to the diaphragms 38, 50. Because the inner flange 70 does not extend the entire interior area otherwise occupied by the diaphragms 38, 50, only a limited segment thereof is understood to be attached to the inner flange 70. That is, at least a part of the front face 60, 64 is attached to the inner flange 70 of the forward and reverse surrounds 40, 52, respectively.

Besides the abutting diaphragms 38, 50, the first embodiment of the passive radiator 12a includes a forward outer gasket 76 and a reverse outer gasket 78, both of which are defined by a front outer gasket surface 80 and a rear outer gasket surface 82. More particularly, the front outer gasket surface 80 of the forward outer gasket 76 is attached to the bottom surface 74 of the outer flange 68 of the forward surround 40, while the rear outer gasket surfaces 82 of the forward and reverse outer gaskets 76, 78 are attached to each other.

FIGS. 4 and 5 illustrate the second embodiment of the passive radiator 12b. Again, this embodiment is generally comprised of the forward radiating element 30 and the reverse radiating element 32 that are in a fixed, abutting relationship to each other. In this regard, the same forward diaphragm 38, reverse diaphragm 50, forward outer gasket 76, and reverse outer gasket 78 are utilized. However, an alternative configuration of the surrounds is contemplated. In further detail, there is a second variation of a forward surround 84 and a reverse surround 86 that is defined by an outer flange 88 and a planar inner section 90 that encompasses the entirety of the area inside or within the cross-sectionally arcuate raised section 89.

Like the first embodiment 12a, the rear face 62 of the forward diaphragm 38 abuts against the rear face 66 of the reverse diaphragm 50. With the second embodiment 12b, however, a substantial entirety of the front face 60 of the forward diaphragm 38 abuts against the planar inner section 90 of the forward surround 84, and a substantial entirety of the front face 60 of the reverse diaphragm 50 abuts against the planar inner section 90 of the reverse surround 86.

The same forward and reverse outer gaskets 76, 78 are each defined by the front outer gasket surface 80 and the rear outer gasket surface 82. The front outer gasket surface 80 of the forward outer gasket 76 is attached to and abuts against the bottom surface 94 of the outer flange 88 of the second embodiment of the forward surround 84. Along these lines, the front outer gasket surface 80 of the reverse outer gasket 78 is attached to and abuts against the bottom surface 94 of the outer flange 88 of the second embodiment of the reverse surround 86. Again, the respective rear outer gasket surfaces 82 of the forward outer gasket 76 and the reverse outer gasket 78 abut against each other.

With reference to FIGS. 6 and 7, a third embodiment of the passive radiator 12c is also comprised of a forward radiating element 30 and a reverse radiating element 32, but are attached to each other differently. The same forward surround 84 and reverse surround 86 of the second embodiment 12b is utilized, and each is understood to have the outer flange 88, the cross-sectionally arcuate section 89, and the planar inner section 90. Furthermore, the forward surround 84 and the reverse surround 86 are each defined by the top surface 92 and the opposed bottom surface 94. Additionally, although the same forward diaphragm 38, reverse diaphragm 50, forward outer gasket, 76 and reverse outer gasket 78 as the first embodiment and second embodiment of the passive radiator 12a, 12b are used, its positioning relative to the surrounds 84, 86 is different.

In accordance with the third embodiment 12c, the forward surround 84 and the reverse surround 86 are attached to each other, and therefore at least partially define the abutting relationship of the forward radiating element 30 and the reverse radiating element 32. In order to secure the bottom surface 94 of the forward surround 84 and the bottom surface 94 of the reverse surround 86, glue may be utilized.

The diaphragms 38, 50 are exposed and attached only to the planar inner section 90 of the surrounds 84, 86, respectively. Again, the forward diaphragm 38 is defined by the front face 60 and the opposed rear face 62, and the reverse diaphragm 50 is defined by the front face 64 and the opposed rear face 66. The rear face 62 of the forward diaphragm 38 abuts against the top surface 92 of the forward surround 84, and the rear face 66 of the reverse diaphragm 50 abuts against the top surface 92 of the reverse surround 86. Thus, the front face 60 of the forward diaphragm 38 defines the forward front face 34 of the forward radiating element 30, while the bottom surface 94 of the forward diaphragm 38 defines the forward rear face 36 of the forward radiating element 30. Similarly, the front face 64 of the reverse diaphragm 50 defines the reverse front face 46 of the reverse radiating element 32, and the bottom surface 94 of the reverse diaphragm 50 defines the reverse rear face 48 of the reverse rear face 48 of the reverse diaphragm 50.

The forward outer gasket 76 and the reverse outer gasket 78 are likewise attached to the respective top surfaces 92 of the forward surround 84 and reverse surround 86. Both of the outer gaskets 76, 78 are further defined by the front outer gasket surface 80 and the opposed rear outer gasket surface 82. The rear outer gasket surfaces 82 thus abut against the respective top surfaces 92 of the forward surround 84 and the reverse surround 86. The front outer gasket surfaces 80 also at least partially define the forward front face 34 of the forward radiating element 30 and the reverse front face 46 of the reverse radiating element 32, respectively.

The particulars shown herein are by way of example and for purposes of illustrative discussion of the embodiments of the present invention only and are presented in the cause of providing what is believed to be the most useful and readily understood description of the principles and conceptual aspects of the passive radiator. In this regard, no attempt is made to show more details than is necessary for a fundamental understanding of the disclosure, the description taken with the drawings making apparent to those skilled in the art how the several forms of the presently disclosed methods may be embodied in practice.

What is claimed is:

1. A passive acoustic radiator, comprising:
a forward radiating element defined by a forward front face, an opposed forward rear face, and including a forward diaphragm coupled to a forward surround defined by an annular raised side coinciding with the forward front face and an opposed annular trough side coinciding with the forward rear face; and
a reverse radiating element defined by a reverse front face, an opposed reverse rear face, and including a reverse diaphragm coupled to a reverse surround defined by an annular raised side coinciding with the reverse front face and an opposed annular trough side coinciding with the reverse rear face;
wherein the forward radiating element and the reverse radiating element are attached to each other with the forward rear face of the forward radiating element being in an abutting relationship to the reverse rear face of the reverse radiating element, an annular open space being defined at least partially by the respective trough sides of the forward and reverse radiating elements.

2. The passive acoustic radiator of claim 1, wherein:
the forward diaphragm is defined by a front face and a rear face that coincides with the forward rear face of the forward radiating element;
the reverse diaphragm is defined by a front face and a rear face that coincides with the reverse rear face of the reverse radiating element; and
the rear face of the forward diaphragm and the rear face of the reverse diaphragm at least partially define the abutting relationship between the forward radiating element and the reverse radiating element.

3. The passive acoustic radiator of claim 2, wherein the forward surround and the reverse surround are annular and include an outer flange and an inner flange each defining a top surface and an opposed bottom surface.

4. The passive acoustic radiator of claim 3, wherein at least a part of the front face of the forward diaphragm is attached to the inner flange of the forward surround, and at least part of the front face of the reverse diaphragm is attached to the inner flange of the reverse surround.

5. The passive acoustic radiator of claim 3, further comprising:
a forward outer gasket attached to the outer flange of the forward surround; and
a reverse outer gasket attached to the outer flange of the reverse surround;
wherein the forward outer gasket is attached to the reverse outer gasket.

6. The passive acoustic radiator of claim 1, wherein the forward surround and the reverse surround each include an outer flange and a planar inner section.

7. The passive acoustic radiator of claim 6, wherein the front face of the forward diaphragm is attached to the planar inner section of the forward surround and the front face of the reverse diaphragm is attached to the planar inner section of the reverse surround.

8. The passive acoustic radiator of claim 6, further comprising:
a forward outer gasket attached to the outer flange of the forward surround; and
a reverse outer gasket attached to the outer flange of the reverse surround;
wherein the forward outer gasket is attached to the reverse outer gasket.

9. The passive acoustic radiator of claim 1, wherein:
the forward surround and the reverse surround each include an outer flange and a planar inner section each defining a top surface and an opposed bottom surface; and
the forward surround and the reverse surround are attached to each other and both at least partially define the abutting relationship between the forward radiating element and the reverse radiating element.

10. The passive acoustic radiator of claim 9, wherein:
the forward diaphragm is attached to the planar inner section of the forward surround; and
the reverse diaphragm is attached to the planar inner section of the reverse surround.

11. The passive acoustic radiator of claim 9, further comprising:
a forward outer gasket attached to the outer flange of the forward surround; and
a reverse outer gasket attached to the outer flange of the reverse surround;
wherein the outer flange of the forward surround is attached to the outer flange of the reverse surround, at least partially defining the abutting relationship between the forward radiating element and the reverse radiating element.

12. The passive acoustic radiator of claim 11, wherein:
the outer flange and the planar inner section of the forward surround coincides with the forward rear face of the forward radiating element;
the outer flange and the planar inner section of the reverse surround coincides with the reverse rear face of the reverse radiating element.

13. The passive acoustic radiator of claim 1, wherein thickness of the forward diaphragm and the reverse diaphragm are substantially the same.

14. The passive acoustic radiator of claim 1, wherein the forward radiating element and the reverse radiating element have a rounded rectangle profile.

15. The passive acoustic radiator of claim 1, wherein forward radiating element and the reverse radiating element are glued to each other.

16. A passive radiator, comprising:
a forward surround defined by a front surround surface and an opposed rear surround surface;
a forward outer gasket defined by a front outer gasket surface attached to the rear surround surface of the forward surround, and an opposed rear outer gasket surface;
a forward diaphragm defined by a front diaphragm surface attached to the rear surround surface of the forward surround, and an opposed rear diaphragm surface;
a reverse surround defined by a front surround surface and an opposed rear surround surface;
a reverse outer gasket defined by a front outer gasket surface attached to the rear surround surface of the reverse surround, and an opposed rear outer gasket surface attached to the rear outer gasket surface of the forward outer gasket; and
a reverse diaphragm defined by a front diaphragm surface attached to the rear surround surface of the reverse surround, and an opposed rear diaphragm surface attached to the rear diaphragm surface of the forward diaphragm.

17. The passive radiator of claim 16, wherein the forward surround and the reverse surround are each annular and defined by an outer flange portion attached to the respective forward and reverse outer gaskets, an inner flange portion attached to the respective forward and reverse diaphragms, and a cross-sectionally arcuate raised section between the outer flange portion and the inner flange portion, an open interior space being defined by the cross sectional arcuate raised sections of both the forward surround and the reverse surround, outer peripheries of the forward and reverse diaphragms, and inner peripheries of the forward and reverse outer gaskets.

18. The passive radiator of claim 16, wherein the forward surround and the reverse surround are each defined by an outer flange portion attached to the respective forward and reverse outer gaskets, an inner planar portion attached to and covering an entirety of the front diaphragm surfaces of the respective forward and reverse diaphragms, and a cross-sectionally arcuate raised section between the outer flange portion and the inner flange portion, an open interior space being defined by the cross sectional arcuate raised sections of both the forward surround and the reverse surround, outer peripheries of the forward and reverse diaphragms, and inner peripheries of the forward and reverse outer gaskets.

19. A passive radiator, comprising:
a forward surround defined by a front surround surface, an opposed rear surround surface, an outer flange portion, and an inner planar portion;
a forward outer gasket defined by a front outer gasket surface and an opposed rear outer gasket surface attached to the outer flange portion of the forward surround;
a forward diaphragm defined by a front diaphragm surface and an opposed rear diaphragm surface attached to the inner planar portion of the forward surround;
a reverse surround defined by a front surround surface, an opposed rear surround surface attached to the rear surround surface of the forward surround, an outer flange portion, and an inner planar portion;
a reverse outer gasket defined by a front outer gasket surface and an opposed rear outer gasket surface attached to the outer flange portion of the reverse surround; and
a reverse diaphragm defined by a front diaphragm surface and an opposed rear diaphragm surface attached to the inner planar portion of the reverse surround.

20. The passive radiator of claim 19, wherein the forward surround and the reverse surround each include a raised arcuate section between the respective outer flange portions and the inner planar portions, the raised arcuate sections defining an open interior space.
